(19) United States
(12) Patent Application Publication
(10) Pub. No.: US 2026/0335880 A1
(43) Pub. Date: Oct. 29, 2026

(54) MICROFLUIDIC FLOW CELL, PRODUCTION METHOD, USE AND ANALYSIS DEVICE

(71) Applicant: THINXXS MICROTECHNOLOGY GMBH, Zweibrücken (DE)

(72) Inventor: Lutz WEBER, Münchweiler (DE)

(21) Appl. No.: 19/104,074

(22) PCT Filed: Aug. 16, 2023
(86) PCT No.: PCT/EP2023/072611

§ 371 Date: Feb. 14, 2025

(30) Foreign Application Priority Data
Aug. 17, 2022 (LU) LU502668

(51) Int. Cl. B01L 3/00

(52) U.S. Cl. CPC B01L 3/502707; B01L 2200/12; B01L 2200/16; B01L 2300/123; B01L 2400/0487

(57) ABSTRACT

A microfluidic flow cell, a production method for a microfluidic flow cell, use of a microfluidic flow cell, and an analysis device. To permit simple production of the flow cell and a particularly good mixing of a dry substance, arranged in a cavity, with a fluid, a passage opens into the cavity and an element inserted in the passage delimits the cavity by means of a deformable wall.

The invention relates to a microfluidic flow cell, to a method of producing a microfluidic flow cell, to a use of a microfluidic flow cell and to an analyzer.

Microfluidic flow cells, as are increasingly used as a “mini-laboratory” for analysis or/and synthesis of fluids, especially in diagnostic testing, often contain a dry substance which has to be introduced into the flow cells during the production of the flow cells. In an assembly step in which there is still access to the cavity, for example a channel or a chamber, intended for accommodating a dry reagent within the flow cell, the dry reagent is introduced by bringing a reagent liquid to be dried, i.e., a carrier liquid with reagent dissolved or suspended therein, to the place in question. This is followed by subjecting the entire flow cell component, which is wetted only in one place with the reagent liquid, to a drying process before assembly of the flow cell is continued, which drying process is often combined with thermal treatment to quicken drying or is carried out as a freeze-drying process for protection of the reagents and in view of stability and resuspension properties. One disadvantage is that the flow cell, the dimensions of which usually far exceed those of the region to be dried only, occupies a large amount of space within a drying chamber. Furthermore, the drying treatment can damage the flow cell itself, especially sensitive components mounted thereon. Furthermore, when completing the assembly of the flow cell, the dry substance formed can then be damaged by contact with air, in particular air humidity, and by the heat of welding or be affected by adhesives which are used for assembly and by means of which corresponding channel regions of a microfluidic flow cell are to be hermetically sealed in many cases. A method for introducing a dry substance into a flow cell, as described above, is disclosed, for example, by EP 2 198 964 B1. It is moreover known through use to preform dry substance as lyophilized (freeze-dried) balls or beads before introducing them into the flow cell.

It is an object of the invention to provide a flow cell of the kind mentioned at the start that is simple to produce and allows particularly good mixing of the dry substance with a fluid. The flow cell according to the invention that achieves this object is characterized in that a passage opens into the cavity and an element inserted in the passage and having a deformable wall delimits the cavity. The passage allows particularly simple introduction of the dry substance into the cavity and the deformable wall adjacent to the cavity makes it possible to alter the cavity and hence influence the dry substance located therein from the outside, as will be described in greater detail hereinafter.

The dry substance is preferably a dry reagent in the form of so-called beads, balls or pellets, which can be produced by lyophilization (freeze-drying) and which have in particular a diameter of 2 to 5 mm. This means that the dry substance is often larger than an adjacent channel of the flow cell.

In one advantageous embodiment, the deformable wall may be sectionally concave and surround a portion of the cavity that is in particular in the form of a cylinder or a sphere section. As a result, a larger volume of dry substance can be located near the deformable wall and be influenced by the deformable wall. Moreover, a comparatively large change in volume can be achieved on movement of the deformable wall, which in particular provides the possibility of minimizing the dead volume and hence air pockets and of, moreover, realizing a pump effect for transfer of the suppliable fluid.

In one particularly advantageous embodiment, the dry substance may be located on an inner face of the deformable wall that faces the cavity, in particular on a concave section of the deformable wall. More advantageously, the deformable wall may at least partly surround the dry substance for frictional and/or form-fitting holding of the dry substance. This makes it possible to position the dry substance at a defined position in the flow cell and moreover facilitates the production of the flow cell, as will be described hereinafter.

The inserted element may have, on an outer face facing away from the cavity, a recess which, for example, may be cylindrical and is preferably adjacent to the deformable wall. When using the flow cell, modules that will be described in detail hereinafter can protrude into the recess in order to move the deformable wall and/or to act on the dry substance located in the cavity.

The inserted element may preferably consist in particular of silicone, thermoplastic elastomer (TPE) or thermoplastic polyurethane (TPU) as a single piece and be formed in particular by injection molding. This allows cost-effective preforming of the element to be later inserted into the flow cell.

Further described is a method for producing the aforementioned microfluidic flow cell, characterized in that the dry substance is introduced into the cavity through the passage. As a result, when producing the flow cell, it can be substantially completed without dry substance before a last step of introducing the dry substance and closing the passage by means of the inserted element. This can in particular preclude any disadvantageous influencing of the dry substance during the production of the flow cell.

Particularly simple production may be achieved by first joining the dry substance with the element to be inserted and then inserting it together with the element into the passage. The element to be inserted protects the dry substance from external influences until the element with the dry substance is inserted into the flow cell. Moreover, the element with the dry substance may be inserted by machine in a particularly simple manner, since the element to be inserted has a defined shape and can be readily gripped by machine as well.

Particularly advantageously, the dry substance may be held frictionally and/or form-fittingly in the element to be inserted. This is achieved by the dry substance elastically deforming the deformable wall of the element to be inserted. If the geometry of the element to be inserted and, in particular, the deformable wall is matched with the dry substance such that the dry substance is engaged behind, the dry substance is also held form-fittingly. As a result, the element to be inserted, with the dry substance, can be preformed and stored in a particularly simple manner, precluding unintended detachment of the dry substance from the element to be inserted prior to mounting on the flow cell.

Additionally or alternatively, the dry substance may be held magnetically and/or electrostatically on insertion into the cavity. In this case, an additional magnetically active element comprising a permanent magnet and/or an electromagnet may be provided.

Further claimed is the use of the aforementioned microfluidic flow cell for analysis of a sample, characterized in that the deformable wall is moved in order to distribute the dry substance in a fluid supplied to the cavity. The deformable wall makes it particularly simple to apply a mechanical force on the dry substance and/or the fluid located in the cavity, thereby quickening the distribution of the dry substance in the fluid. The deformable wall may also be moved to protrude into the channel, thereby reducing the channel cross-section and assisting the distribution of the dry substance. Additionally or alternatively, the dry substance may also comprise magnetically active components which are acted on magnetically via the deformable wall in order to distribute the dry substance in a supplied fluid. The magnetic action on a dry substance in a flow cell is a separate invention irrespective of the presence of an inserted element and a deformable wall.

Particularly advantageously, the deformable wall may preferably be elastically moved to such an extent that the dry substance is pressed against a wall of the flow cell and thereby comminuted. This mechanical comminution of the dry substance likewise quickens distribution in the supplied fluid.

The deformable wall may be moved successively in different, preferably opposite, directions in order to alternately increase and decrease the volume of the cavity. As a result, a pump effect which moves the supplied fluid within the cavity and the at least one adjacent channel can be achieved, which additionally quickens the distribution of the dry substance in the fluid.

Particularly advantageously, the fluid may be supplied to the cavity only after the cavity has been decreased by the deformable wall. As a result, unnecessary dead spaces and hence, for example, air pockets within the cavity are avoided. The fluid can be supplied by elastic recovery of the deformable wall and the negative pressure thus produced in the cavity. Alternatively or additionally, a negative pressure may also be applied to the outer face of the deformable wall, which negative pressure pulls back the deformable wall.

Further claimed as well is an analyzer for analysis of a sample by means of the aforementioned microfluidic flow cell, characterized in that an operating device for movement of the deformable wall is provided. The operating device may advantageously comprise a movable plunger and/or a pipe for application of a negative pressure and/or positive pressure in order to move the deformable wall. Moreover, the analyzer may comprise at least one magnetically active element which acts on the dry substance. For example, magnetically active components such as metal parts may thus be provided in the dry substance, which components can be held or moved magnetically in order to keep the dry substance at a particular place or to promote the distribution of the dry substance in the fluid. The analyzer may comprise at least one supply line and/or discharge line to/from the flow cell for a sample and/or at least one sensor for determination of the location of a fluid or a sample in the flow cell or for analysis of a sample processed in the flow cell. The supply line and/or discharge line may be pressable against the flow cell in order to produce a hermetic connection. Reference is made to LU502668, the content of which is hereby incorporated in this application. The former discloses further embodiments and uses of the inventive flow cell with inserted element (referred to therein as “reagent plug”, or RP for short) and movable wall (referred to therein as “flexible wall”, or FW for short) and a corresponding analyzer.

Further peculiarities and preferences of the invention will become apparent from the following description of preferred exemplary embodiments with reference to the drawings, where:

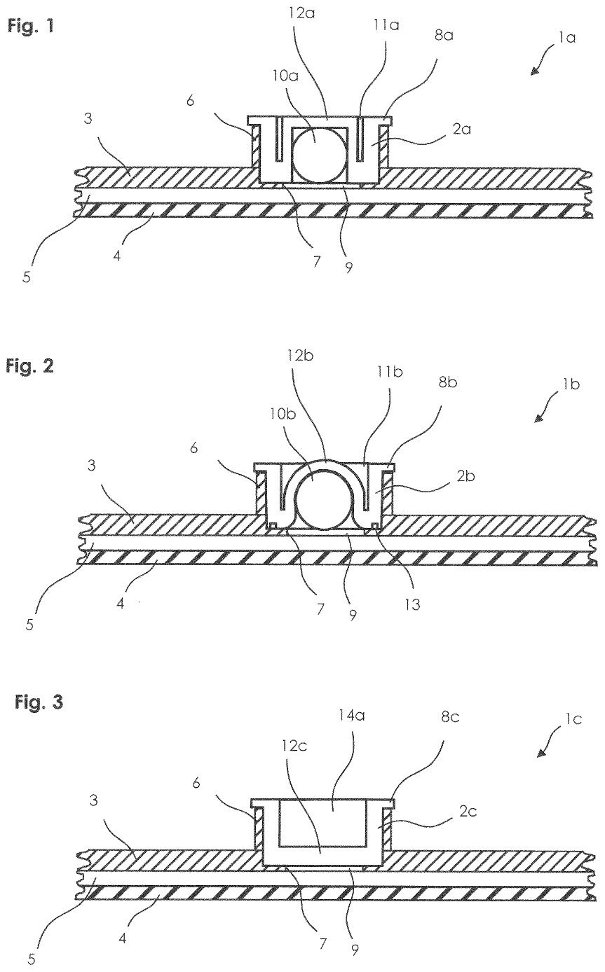

FIG. 1 shows a longitudinal section through a flow cell with an inserted element and a dry substance according to a first embodiment;

FIG. 2 shows a longitudinal section through a flow cell with an inserted element and a dry substance according to a second embodiment;

FIG. 3 shows a longitudinal section through a flow cell with an inserted element without dry substance according to a third embodiment;

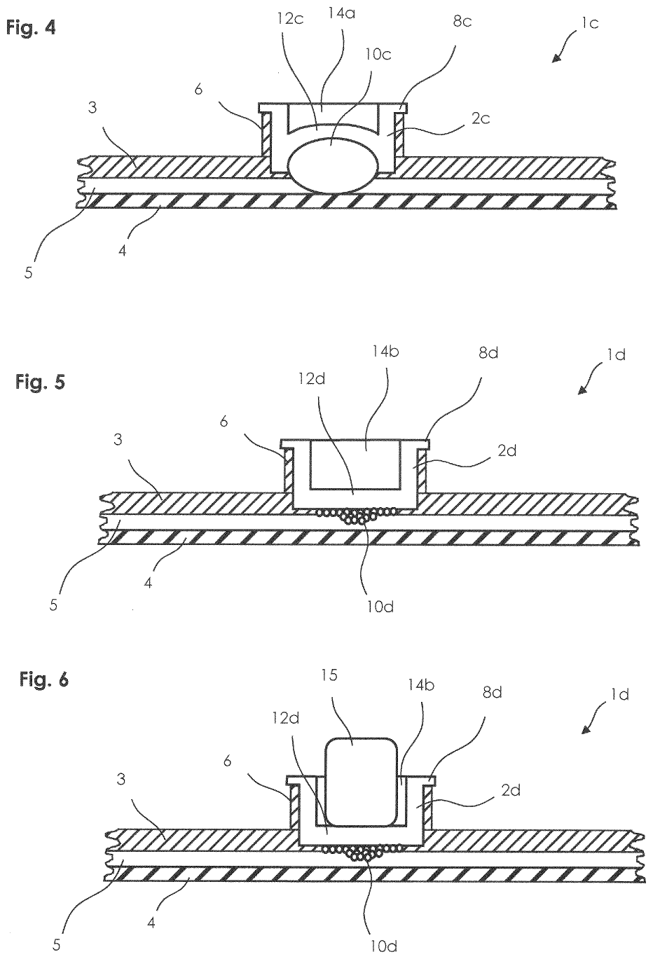

FIG. 4 shows a longitudinal section through the flow cell shown in FIG. 3 with a dry substance;

FIG. 5 shows a longitudinal section through a flow cell with an inserted element and a dry substance according to a fourth embodiment;

FIG. 6 shows a longitudinal section through the flow cell of FIG. 5 with an additional magnet;

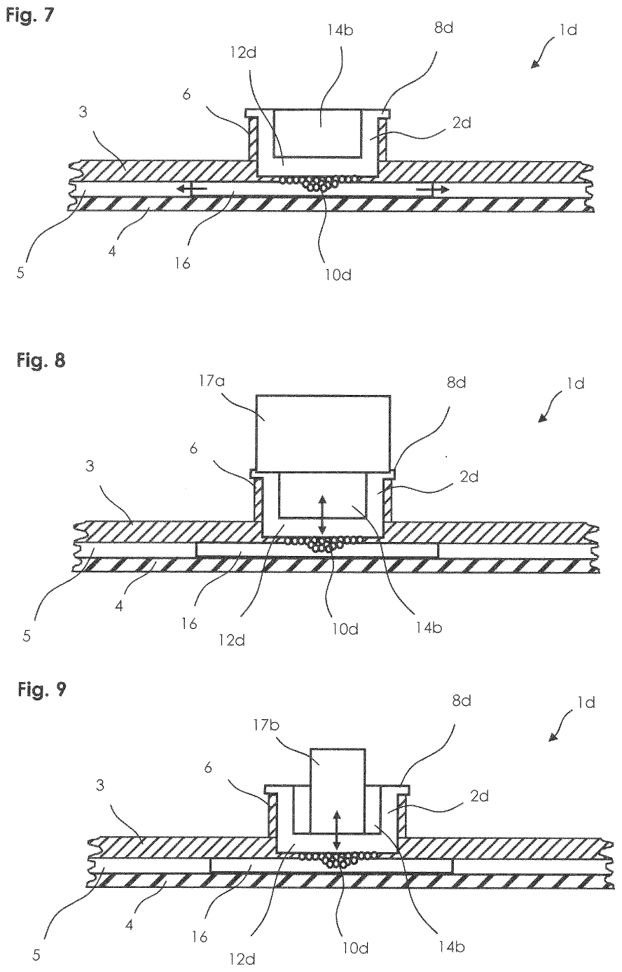

FIG. 7 shows a longitudinal section through the flow cell of FIG. 5 with a supplied fluid;

FIG. 8 shows a longitudinal section through the flow cell of FIG. 7 with a pneumatic operating device;

FIG. 9 shows a longitudinal section through the flow cell of FIG. 7 with a mechanical operating device;

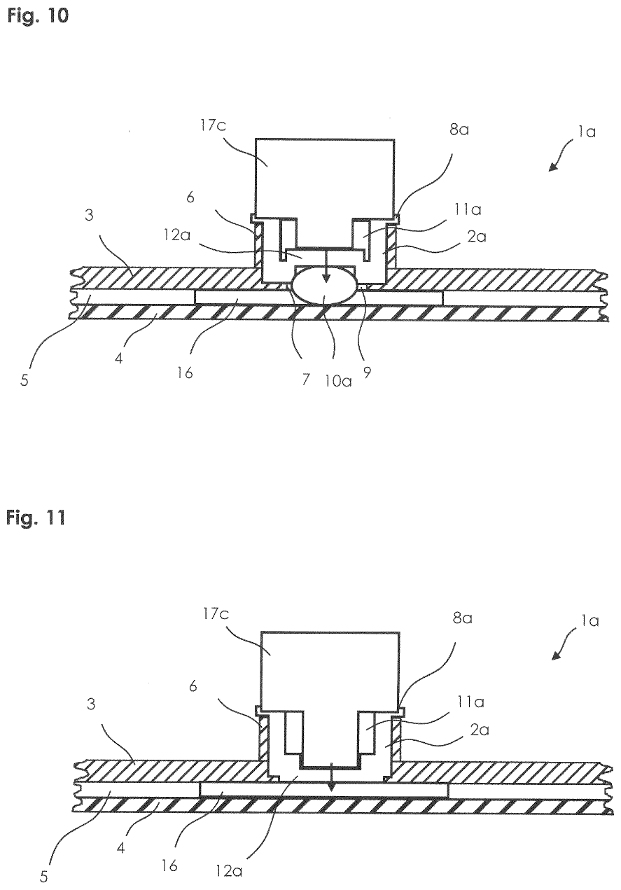

FIG. 10 shows a longitudinal section through the flow cell of FIG. 1 with a supplied fluid and an operating device in a first actuation position;

FIG. 11 shows a longitudinal section through the flow cell of FIG. 1 with the operating device in a second actuation position;

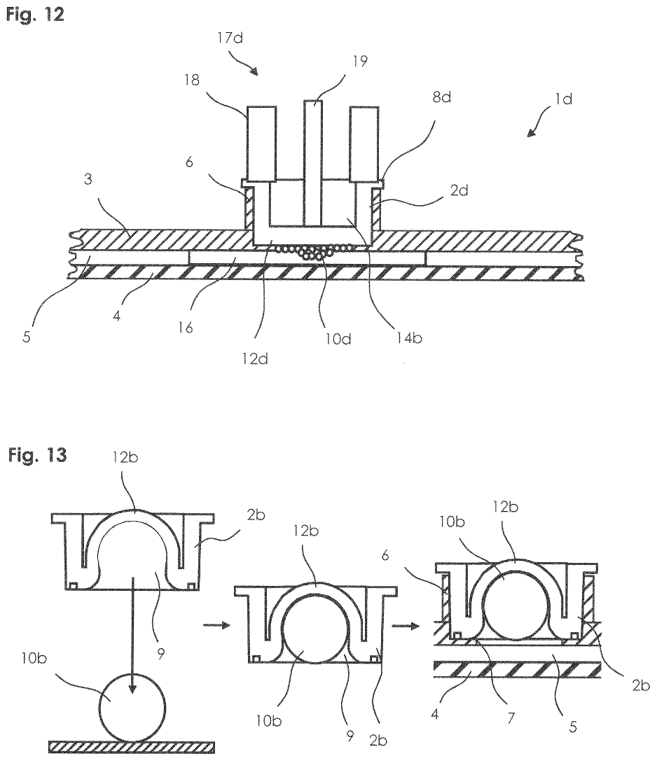

FIG. 12 shows a longitudinal section through the flow cell of FIG. 7 with an operating device, and

FIG. 13 shows the sequence of three steps in preforming the unit composed of the element to be inserted and the dry substance.

FIG. 1 shows a longitudinal section through a flow cell 1a with an inserted element 2a according to a first embodiment. As is known, the flow cell 1a comprises a substantially level, planar substrate 3 which is covered on its lower face by a film 4. The film 4 is preferably heat-sealed or adhesively bonded with the substrate 3. Provided in the substrate 3 is at least one channel 5 which is delimited by the film 4. Particularly simple production of such a flow cell 1a can be achieved by producing the substrate by injection molding, preferably from a plastic, followed by covering the outwardly open channel 5 with the film 4 in order to allow secure inward and outward transfer of liquid within the channel 5 through an inlet and an outlet. The substrate 3 may be made of a plastic such as PP, PC, PMMA, COC, COP or PS and the inserted element 2a may be made of a thermoplastic elastomer such as PU, TPE, silicone, or vice versa. In a region of the substrate 3 that is not shown, a detection region for analysis of a mixture of sample and dry substance may be provided.

On the side of the substrate 3 facing away from the film 4, the substrate 3 comprises a protruding, preferably annular sleeve 6 through which an outwardly open passage 7 opens into the channel 5. Inserted into the passage 7 from the outside is the element 2a, with a laterally protruding annular collar 8a being positioned on the sleeve 6 and thereby forming a depth limit for the element 2a inserted into the sleeve 6. Additionally or alternatively, a depth stop may also be realized on the passage. The element 2a preferably delimits a cavity 9 in the passage 7 that moreover extends into the inserted element 2a, where a spherical dry substance 10a is located. Provided around the cavity 9 in the upper region, on an outer face of the inserted element 2a, is an annular groove 11a which is spaced from the cavity 9 by a thin wall. In the longitudinal section shown, the contour of the inserted element 2a has roughly a W-shape. The wall 12a of the inserted element 2a that abuts on the dry substance 10 and surrounds it is deformable, for example composed of an elastic material such as silicone, TPE or TPU, which makes it particularly simple to apply a force to the dry substance 10a from the outside. In the longitudinal section, the walls of the inserted element 2a are at right angles to one another. In the transverse section which extends horizontally in FIG. 1, the inserted element 2a, as in the other figures too, preferably has a circular, rotation-symmetric shape.

In the embodiment of FIG. 1 and the other embodiments described hereinafter, the surfaces of the inserted element that face the cavity and/or the surface of the channel may be hydrophilically modified, for example nonpermanently by surface activation by means of plasma treatment, or coated (permanently, for example by plasma polymerization or coating with suitable liquids) in order to assist the introduction of samples and/or the redissolving of the dry substance. The pretreatment for hydrophilic surface properties may include a contact angle in relation to water <60°, preferably <30° (wet-chemically, plasma treatment, corona, coating with a vitreous layer, for example by plasma polymerization, or with metal, for example by means of printing or thin-film technology). Moreover, the surface of the inserted element may preferably be flush with one of the walls of the channel.

FIG. 2 shows a longitudinal section through a flow cell 1b with an inserted element 2b and a dry substance 10b according to a second embodiment. As with the following figures too, the substrate 3, with the sleeve 6 and with the channel 5 having the passage 7, and the film 4 are identical, and so the same reference signs are used. As can be seen by comparison with the embodiment of FIG. 1, the embodiment of the inserted element 2b shown in FIG. 2 differs especially in that, in the longitudinal section, the deformable wall 12b which abuts on the dry substance 10b is curved, in particular has the shape of a circular segment, and hence the entire surface thereof abuts on the spherical dry substance 10b. To ensure the depth of the inserted element 2b in the passage 7, the element 2b likewise comprises a laterally protruding annular collar 8b. A corresponding annular groove 11b is formed according to the curvature of the deformable wall 12b. Additionally also shown is an annular gasket 13 which is arranged in an annular groove on the end face of the inserted element 2b facing the substate 3 and allows reliable sealing between the substrate 3 and the inserted element 2b. Such an annular gasket may also be provided in the embodiments of the inserted element that are shown in the other figures, even though this is not shown for all figures for simplicity.

FIGS. 3 and 4 both show a longitudinal section through a flow cell 1c according to a third embodiment, with FIG. 3 showing the flow cell 1c with an inserted element 2c without dry substance and FIG. 4 showing this with dry substance 10c. As can be seen by comparison of FIGS. 3 and 4, the deformable wall 12c of the element 2c is originally level and is delimited on the outer face by a cylindrical recess 14 in the inserted element 2c. The position of the deformable wall 12c shown corresponds to the state when a previously existing dry substance has been completely dissolved in a supplied fluid and discharged through the channel 5. FIG. 4, by contrast, shows the flow cell 1c after it has been produced, with the inserted element 2c and with the dry substance 12c located in the cavity 9. The dry substance 12c abuts on the film 4 and presses against the deformable wall 12c, which preferably elastically arches outward in the direction of the recess 14a. This prestressing facilitates the mechanical comminution of the dry substance 10c through a force additionally acting from the outside on the deformable wall 12c and reduces the dead volume, meaning that less fluid is also required.

FIGS. 5, 6 and 7 show a flow cell 1d with an inserted element 2d and a dry substance 10d in the form of a multiplicity of beads according to a fourth embodiment. The individual beads of the dry substance 10d are influenceable magnetically, i.e., comprise either a magnetic component, such as a permanent magnet, or a magnetizable component, such as a metal. After the flow cell 1d has been produced, the inserted element 2d, which may be identical to the embodiment shown in FIGS. 3 and 4, holds the dry substance 10d, composed of beads, on the deformable wall 12d in the cavity 9, which is not numbered here, either by magnetic forces or in some other way, for example by adhesion or a dissolvable adhesive. Some of the beads of the dry substance 10d also protrude into the channel 5, which is advantageous in later distribution and dissolving of the dry substance 10b in a supplied fluid.

FIG. 6 additionally shows a magnet 15 which protrudes into the recess 14b and externally abuts on the deformable wall 12d opposite the dry substance 10d. The magnet 15, which may be in the form of a permanent magnet or electromagnet, can bring about a magnetic force on the dry substance 10d, in particular an attracting force and/or a repelling force. This can assist the distribution of the dry substance 10d in a supplied fluid and, moreover, components of the dry substance 10d which are not dissolved in the fluid can be collected and held again by the magnet 15. Here, the magnet 15 may additionally be pressed against the deformable wall 12d in order to bring about movement of the deformable wall 12d and hence the dry substance 10d and of a supplied fluid, which additionally assists the distribution of the dry substance in the fluid. Moreover, a wall 12d deformed in the direction of the channel reduces the channel cross-section, thereby also increasing the magnetic effect in the channel 5.

FIG. 7 shows a way of distributing and dissolving the dry substance 10d in the form of beads by movement of a fluid 16 located in the channel 5. The fluid 16 may preferably be reciprocated periodically, for example by a positive pressure alternately applied at the ends of the channel 5. Additionally, as shown in FIG. 7, a magnet 15 which acts on the dry substance 10d magnetically and optionally via movement may also be provided.

FIGS. 8 and 9 show the flow cell 1d of FIG. 7 in longitudinal section with different operating devices. Provided in the embodiment shown in FIG. 8 is a pneumatic operating device 17a which abuts sealingly on the inserted element 2d, in particular on the annular collar 8d, and is designed to produce a negative pressure and/or positive pressure in the recess 14b. Since the recess 14b is airtightly closed by way of the pneumatic operating device 17a, a positive pressure and/or negative pressure leads to the arrow-indicated movement of the deformable wall 12d, as a result of which the dry substance 10d in the form of beads is particularly thoroughly distributed in the fluid 16. If the negative pressure and/or positive pressure is applied periodically, the deformable wall 12d and hence also the fluid 16 can be made to oscillate, which additionally assists the distribution of the dry substance 10d.

Provided in FIG. 9 is a mechanical operating device 17b which, for example, is in the form of a plunger and protrudes into the recess 14b and abuts on the deformable wall 12d. When the mechanical operating device 17b moves in the direction of the deformable wall 12d, the deformable wall 12d is deflected and thereby likewise transmits motion onto the dry substance 10d and the fluid 16. The mechanical operating device 17b may likewise move periodically in order to additionally assist the distribution of the dry substance 10d in the fluid 16.

FIGS. 10 and 11 show the flow cell 1a of FIG. 1 with a supplied fluid and with an operating device 17c in different actuation positions. In the actuation position shown in FIG. 10, the operating device 17c which is shown schematically here and which may be a pneumatic or mechanical operating device is provided for movement of the deformable wall 12a in the direction of the dry substance 10a. Here, the deformable wall 12a and the originally spherical dry substance 10a are already deformed. At and above a particular degree of deformation, the dry substance 10a breaks into multiple small portions which distribute and dissolve particularly readily in the fluid 16. This state is shown in FIG. 11, the deformable wall 12a completely filling the passage 7 and the cavity 9, such that only the channel 5 with the fluid 16 located therein remains and the dry substance 10a is completely distributed and dissolved in the fluid 16.

FIG. 12 shows a longitudinal section through the flow cell of FIG. 7 with an operating device 17d. As can be seen in said figure, abutting sealingly on the inserted element 2b, in particular on the annular collar 8d, is a pipe 18, only a section of which is shown here and through which a negative pressure and/or positive pressure can be introduced into the recess 14d in order to move the deformable wall 12d as described above. Additionally, provided preferably concentrically in the pipe 18 is a, for example, rod-shaped magnet 19 which extends into the recess 14b and abuts on the outer face of the deformable wall 12d. As a result, magnetic components of the dry substance 10d can be held and, moreover, moved by way of the negative pressure and/or positive pressure introducible into the pipe 18.

FIG. 13 shows the sequence of three steps in preforming a unit composed of element to be inserted, using here the example of the element 2b to be inserted, and the dry substance, using here the example of the dry substance 10b. As can be seen in the picture on the left, a first step comprises inserting the dry substance 10b into the cavity 9 within the element 2b and holding it there preferably form-fittingly and/or frictionally. The picture in the center shows a unit preformed in this way, which can also be easily stored. The picture on the right shows the last step, in which the preformed unit is inserted into the passage 7 within the sleeve 6 of the flow cell. This preforming can especially also reliably prevent contamination of the dry substance 10b and mechanical stress during storage and transport, since the dry substance 10b is gripped and held not directly, but solely by way of the element 2b.

The embodiments shown in the various figures can be readily combined. For example, the various operating devices may also be provided on the other inserted elements. The various inserted elements and the different operating devices may therefore be combined in any variation.

### List of Reference Signs

1a, 1b, 1c, 1d Flow cell
2a, 2b, 2c, 2d Inserted element
3 Substrate
4 Film
5 Channel
6 Sleeve
7 Passage
8a, 8b, 8c, 8d Annular collar
9 Cavity
10a, 10b, 10c, 10d Dry substance
11a, 11b Annular groove
12a, 12b, 12c, 12d Wall
13 Annular gasket
14a, 14b Recess
15 Magnet
16 Fluid
17a, 17b, 17c, 17d Operating device
18 Pipe
19 Magnet

1-18. (canceled)

19. A microfluidic flow cell, comprising: a cavity; a dry substance located in the cavity within the flow cell for interaction with a fluid suppliable to the cavity;
a passage that opens into the cavity; and an element inserted in the passage and having a deformable wall that delimits the cavity.

20. The flow cell according to claim 19, wherein the deformable wall is at least sectionally concave and surrounds at least a portion of the cavity.

21. The flow cell according to claim 19, wherein the deformable wall surrounds a portion of the cavity that is formed as a cylinder or a sphere section.

22. The flow cell according to claim 19, wherein the dry substance is located on an inner face of the deformable wall that faces the cavity.

23. The flow cell according to claim 22, wherein the dry substance is located on a concave section of the deformable wall.

24. The flow cell according to claim 22, wherein the deformable wall at least partly surrounds the dry substance.

25. The flow cell according to claim 19, wherein the inserted element has, on a face facing away from the cavity, a recess that is cylindrical.

26. The flow cell according to claim 19, wherein the inserted element is made of silicone, TPE or TPU and is formed in particular by injection molding.

27. The flow cell according to claim 26, wherein the inserted element is an injection molded element.

28. A method for producing a microfluidic flow cell according to claim 19, comprising the step of introducing the dry substance into the cavity through the passage.

29. The method according to claim 28, including first joining the dry substance with the element and then inserting the dry substance together with the element into the passage.

30. The method according to claim 29, including holding the dry substance frictionally and/or form-fittingly in the element.

31. The method according to claim 28, including holding the dry substance magnetically and/or electrostatically on insertion into the cavity.

32. a method for analyzing a sample, comprising the steps of: using a microfluidic flow cell according to claim 19; and moving the deformable wall is moved to distribute the dry substance in a fluid supplied to the cavity.

33. The method according to claim 32, including moving the deformable wall so that the dry substance is pressed against a wall of the flow cell and thereby comminuted.

34. The method according to claim 32, including moving the deformable wall successively in different directions to alternately increase and decrease a volume of the cavity.

35. The method according to claim 34, including supplying the fluid to the cavity only after the cavity has been decreased by the deformable wall.

36. An analyzer for analysis of a sample, comprising: a microfluidic flow cell according to claim 19; and an operating device configured to move the deformable wall.

37. The analyzer according to claim 36, wherein the operating device comprises a movable plunger and/or a pipe for application of a negative pressure and/or positive pressure to move the deformable wall.

38. The analyzer according to claim 36, further comprising a magnetically active element arranged to act on the dry substance.
